(19) United States
(12) Patent Application Publication
(10) Pub. No.: US 2019/0394511 A1
(43) Pub. Date: Dec. 26, 2019

(54) SYSTEMS AND METHODS FOR GENERATING AND PRESENTING CONTENT-BASED SUMMARIES AND RECOMMENDATIONS

(71) Applicant: Wells Fargo Bank, N.A., San Francisco, CA (US)

(72) Inventors: Chris Kalaboukis, San Jose, CA (US); Benjamin S. Taylor, Williston, VT (US)

(21) Appl. No.: 16/014,662

(22) Filed: Jun. 21, 2018

(51) Int. Cl. H04N 21/262; H04N 21/258; H04N 21/2668; H04N 21/854

(52) U.S. Cl. CPC H04N 21/26258; H04N 21/854; H04N 21/2668; H04N 21/25891

(57) ABSTRACT

The provider computing system includes a network interface configured to facilitate communication between the provider computing system, a content source, and a user device. The provider computing system includes a processing system that includes a processor and memory. The memory is structured to store instructions that are executable by the processor to cause the processor to monitor content from the content from the content source to detect relevant content relating to a user, extract a plurality of relevant pieces of content from the monitored content, assemble the relevant pieces of content to create a presentation, generate a recommendation based on the relevant pieces of content, incorporate the recommendation in the presentation, and provide the presentation to the user device.

### TECHNICAL FIELD

The present disclosure relates generally to the field of automated systems configured to process news and other content to generate a recommendation and communicate the news and the recommendation to a user.

### BACKGROUND

Extraordinary amounts of information are available to a person using electronic devices such as smartphones, personal computers, voice assistants, televisions, and radios. This information includes news reports, interviews, and opinion pieces in written, audio, and audio-video formats (e.g., news articles, radio broadcasts, television broadcasts, internet resources), social media posts and activity, government filings such as SEC disclosures, company websites, academic publications, and more. Frustratingly, only certain difficult-to-locate nuggets of information may be relevant to a particular person. In addition, the relevance of much of this information is typically time-sensitive, as it may only be useful to a person for a limited amount of time. For example, a piece of news relevant to an investment decision may only be useful if the person receives the news and comprehends its relevance in time to make an informed, advantageous decision (e.g., before an opportunity disappears). Often, this vast amount of information is overwhelming, limiting the utility of both the information itself and of the electronic devices and systems used by a person to access it.

### SUMMARY

One embodiment of the present disclosure is a provider computing system. The provider computing system includes a network interface configured to facilitate communication between the provider computing system, a content source, and a user device. The provider computing system includes a processing system that includes a processor and memory. The memory is structured to store instructions that are executable by the processor to cause the processor to monitor content from the content from the content source to detect relevant content relating to a user, extract a plurality of relevant pieces of content from the monitored content, assemble the relevant pieces of content to create a presentation, generate a recommendation based on the relevant pieces of content, incorporate the recommendation in the presentation, and provide the presentation to the user device.

Another implementation of the present disclosure is a method. The method includes storing, by a provider computing system, a user profile. The method also includes monitoring, by the provider computing system, content from a content source to detect relevant content, the relevant content relating to the user profile. The method also includes extracting a plurality of relevant pieces of content from the monitored content, assembling the relevant pieces of content to create a presentation, generating a recommendation based on the relevant pieces of content, incorporating the recommendation in the presentation, and providing the presentation to a user device.

Another implementation of the present disclosure is a user device. The user device includes a network interface configured to facilitate communication between the user device and a content source. The user device includes a processing system that includes a processor and memory. The memory is structured to store instructions that are executable by the processor to cause the processor to monitor content from the content source to detect relevant content relating to a user, extract a plurality of relevant pieces of content from the monitored content, assemble the relevant pieces of content to create a presentation, generate a recommendation based on the relevant pieces of content, incorporate the recommendation in the presentation, and incorporate an option to implement the recommendation in the presentation. The user device also includes an input/output circuit to provide the presentation to the user device.

### BRIEF DESCRIPTION OF THE DRAWINGS

FIG. 1 is a block diagram of a system for providing a news summary and a recommendation to one or more user devices and implementing the recommendation, according to an example embodiment.

FIG. 2 is a flow chart of a process for providing news summaries, recommendations, and options to accept the recommendations to one or more user devices in a variety of formats, according to an example embodiment.

FIG. 3 is a process of providing news flash notifications and periodic news briefings including recommendations to one or more user devices, according to an example embodiment.

FIG. 4 is a depiction of a user mobile device with a graphical user interface including summaries and recommendations in a variety of output formats, according to an example embodiment.

FIGS. 5A-D are depictions of a television displaying a video-based summary including an option to implement a recommendation included with the video-based summary, according to an example embodiment.

FIG. 6 illustrates a watch displaying a text-based summary, recommendation, and a user-selectable option to implement that recommendation, according to an example embodiment.

### DETAILED DESCRIPTION

Referring generally to the FIGURES, systems, methods, and apparatuses for locating, curating, and presenting content relevant to a user and generating and presenting actionable recommendations based on that content are shown, according to example embodiments. In general, the systems, methods, and apparatuses disclosed herein provide for locating content relevant to a user's goals and situation, curating that content to generate a summary of the relevant content, generating a recommended action based on the content, and providing the summary, the recommended action, and an option to implement the recommend action to a user in a variety of formats.

As an example, an example user of the system described herein lives in Detroit and desires to save up enough money for a down payment on a home and a new car. The system scans the user's own financial data as well as other content such as news and other web-based content and/or social media activity to locate content that could assist the user in achieving those goals. The system identifies a social media post from another Detroit resident stating that the resident just got a low interest rate from a particular bank. The user may not follow the other Detroit resident on social media, or may not ever use the particular social media platform, yet the system identifies this relevant content from among countless numbers of user-generated content accessible on the social media platform. The system checks for other content relevant to the bank or to the Detroit housing market, and generates a summary of the content that includes the post about the low interest rate. Based on the available content and the customer's financial situation and goals, the system also generates a recommendation that the user seek a loan from the identified bank. In this example, the summary and the recommendation are provided as part of a system-generated video that includes summarized content, the recommendation, and options that can be selected by the user to instruct the system to initiate the mortgage application process with the bank.

As shown in this example, embodiments of the present disclosure can help users locate information that the users would have difficulty finding, compare that information to other available content, analyze the information, receive recommendations about financial decisions, and implement those financial decisions. Thus, the systems, methods, and apparatuses described herein improve upon existing personal electronic devices and the electronic information sources (e.g., databases, websites) accessible with personal electronic devices by providing a system that efficiently sorts overwhelming informational content to locate relevant and reliable information, curates a summary of the located information, and provides an actionable recommendation determined from the overwhelming content. The technical utility and effectiveness of personal electronic devices and electronic content sources in providing users with relevant content and actionable advice is thereby improved.

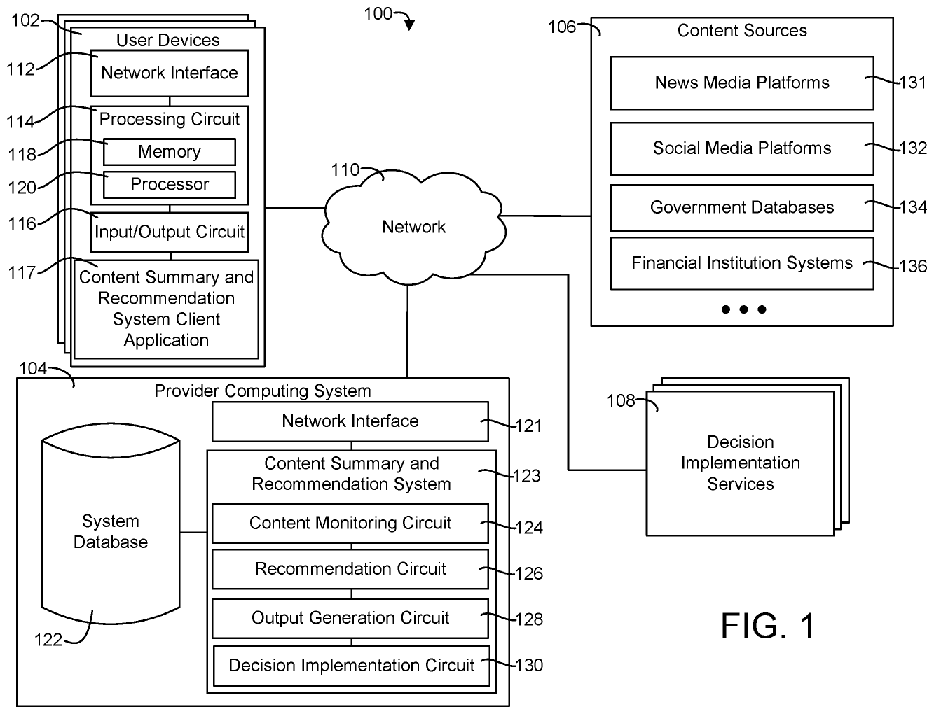

Referring to FIG. 1, a block diagram of a system 100 for providing news summaries and actionable recommendations to one or more users is shown, according to an example embodiment. The system 100 includes user devices 102, a provider computing system 104, content sources 106, decision implementation services 108, and network 110.

Network 110 provides communicable and operative coupling between the user devices 102, the provider computing system 104, content sources 106, and decision implementation services 108. In various embodiments, the network 110 includes any type or types of network, including wired (e.g., Ethernet) and/or wireless networks (e.g., 802.11X, ZigBee, Bluetooth, Internet, WiFi, etc.).

User devices 102 are configured to receive content from the provider computing system, communicate that content to a user, and receive input from a user relating to the content, for example a selection of an option to follow a recommendation generated by the provider computing system. According to various embodiments, are user devices 102 are one or more of a variety of types of electronic devices including mobile devices (e.g., smartphones, tablets, portable gaming devices, personal digital assistant), personal computers (e.g., laptop, desktop computer), televisions and television accessories (e.g., smart televisions, projectors, gaming consoles, DVD/Blu-ray players, digital cable/satellite boxes, media streaming devices), voice assistants, automobile entertainment systems, and wearable devices (virtual reality headsets, augmented reality headsets, smart watches, fitness trackers). Each user device 102 is operably and communicably coupled to the provider computing system 104, content sources 106, and decision implementation services 108 via network 110.

Each user device 102 includes a network interface 112, a processing circuit 114, an input/output circuit 116, and a content summary and recommendation system client application 117. Network interface 112 includes program logic that facilitates connection of the user device 102 to the network 110. Accordingly, the network interface supports communication via network 110 between the user device 102, the provider computing system 104, content sources 106, and decision implementation services 108. The network interface 112 may include a cable modem, a broadband modem, a cellular modem, a Bluetooth transceiver, a Bluetooth beacon, a radio-frequency identification (RFID) transceiver, and/or a near-field communication (NFC) transmitter. In some embodiments, the network interface 112 includes cryptography capabilities to establish a secure or relatively secure communication session.

The processing circuit 114 is configured to control at least partly the user device 102 as described herein. The processing circuit 114 includes memory 118 and processor 120. The processor 120 may be implemented as a general-purpose processor, an application specific integrated circuit (ASIC), one or more field programmable gate arrays (FPGAs), a digital signal processor (DSP), a group of processing components, or other suitable electronic processing components. The one or more memory devices of memory 118 (e.g., RAM, ROM, NVRAM, Flash Memory, hard disk storage, etc.) may store data and/or computer code for facilitating at least some of the various processes described herein. In this regard, the memory 118 may store programming logic that, when executed by the processor 120, controls the operation of the user device 102.

The input/output circuit 116 is structured to receive from and provide communication(s) to a user of the user device 102. The input/output circuit 116 includes one or more input/output components that interface with a user (e.g., screens, speakers, microphones, remotes, buttons, touchscreens, vibration mechanisms) as well as any combination of hardware components, communication circuitry, and machine-readable media for facilitating the exchange of information between the input/output components and elements of the user device 102, including the processing circuit 114 and the network interface 112. For example, in an embodiment where the user device 102 is a smartphone or a tablet, the input/output components may include a touch screen, one or more speakers, one or more microphones, one or more cameras, and/or a fingerprint reader. In an embodiment where the user device is a television, the input/output components may include a television display (e.g., liquid-crystal-display, plasma display, light-emitting-diode display), one or more speakers, and a remote control with buttons that can be pressed by a user. In an embodiment where the user device 102 is a smart watch, the input/output components may include a screen, a speaker, a vibration generator, and a touch-sensitive bezel, screen, and/or buttons. The input/output circuit 116 thereby facilitates two-way transfer of information between a user and a user device 102.

The content summary and recommendation system client application 117 is configured to facilitate operation of the content monitoring, summarizing, and recommendation functions described herein. More particularly, in some embodiments, the content summary and recommendation system client application 117 is configured to provide some or all of the features attributed herein to the content summary and recommendation system 123 of the provider computing system. According to various embodiments, the content summary and recommendation system client application 117 includes a server-based application executable on the user device 102 (e.g., such that the content summary and recommendation system client application 117 must be downloaded prior to usage), a web-based interface application accessible via a browser, and/or its own set of dedicated or substantially dedicated hardware components and associated logic. All such variations and combinations are intended to fall within the scope of the present disclosure.

Content sources 106 are sources of content relating to a user (e.g., relating to user's financial standing and planning) accessible via network 110. For example, network 110 may be the internet and the content sources 106 may be accessible via the internet. “Content” refers to facts, opinions, stories, information, etc. available via network 110 (e.g., accessible via the internet). Content sources 106 are configured to be automatically accessed by the provider computing system 104 to allow the provider computing system 104 to copy, download, or otherwise acquire content. In some cases, the provider computing system 104 views internet-accessible webpages to acquire content (e.g., by scraping public-facing webpages), including webpages protected by paywalls. In some cases, the provider computing system 104 directly accesses servers, databases, or other back-end computing systems that contain relevant content. For example, the provider computing system 104 may be communicable with a database of news stories maintained by a news organization, bypassing the news organization's browser-accessible webpage. As shown in FIG. 1, content sources 106 include news media platforms 131, social media platforms 132, government databases 134, and financial institution systems 136, among other possible sources such as real estate listings, car dealership databases, and vacation booking systems.

News media platforms 131 are outlets for information about current events, developments in politics, the economy, technology, businesses, etc., investigative journalism, and other topics, including websites, television broadcasts, newspaper and periodical publications, radio broadcasts, etc. Accordingly, the content provided on news media platforms 131 is generally accessible via the internet through news websites, streaming services, databases, and other servers or computing systems of news entities (e.g., journalism/media companies) or news aggregators.

Social media platforms 132 are internet-accessible services (e.g., websites, servers) that host user-created content. Social media platforms 132 include sources of user-created content such as Facebook, Twitter, Instagram, Reddit, and LinkedIn. Content posted on social media platforms 132 is often publically available via the internet, and the provider computing system 104 may monitor this publically available data via by monitoring webpages. In some embodiments, the provider computing system 104 has special access to social media data of the social media platforms 132, for example as purchased from social media platform companies. In some embodiments, the provider computing system 104 uses login information provided by users of user devices 102 to gain access to content protected by privacy settings.

Government databases 134 are computing systems that store government-generated content and/or content submitted to the government by private entities. For example, this content may include filings, applications, guidance, and decisions related to environmental regulations, drug regulations, medical device regulations, transportation regulations, financial regulations, and other regulations; tax payments, forms, and filings; court filings and litigation documents; criminal records and police records; new regulations and legislation; and government contracts and spending.

Financial institution systems 136 are computing systems that store information corresponding to a user's own financial situation (e.g., the user's bank and credit card account balances, investment portfolio, mortgage information) and systems that contain content relating to stock prices, investment opportunities, interest rates, macro-economic trends, and other economic information relating to a user's economic situation. Accordingly, financial institution systems 136 may include banking systems, credit card provider systems, stock exchange systems, investment management systems, and credit score reporting and monitoring services, among others.

Decision implementation services 108 are configured to implement decisions made by a user or on behalf of a user relating to recommendations generated by the provider computing system 104. For example, decision implementation services 108 may include a computerized trading system that automatically buys and sells stocks as directed and/or a system that instructs a stock broker to complete a specified trade. As another example, decision implementation services 108 may include a system that purchases plane tickets, books vacation deals, or makes other purchases on behalf of a user. As another example, decision implementation services 108 may include a system that automatically initiates mortgage or loan applications, transfers funds between bank accounts, pays bills, opens new accounts (e.g., savings accounts, credit card accounts), changes retirement fund elections, or otherwise implements a user's decisions.

Provider computing system 104 is configured to locate content relevant to a user, curate that content to generate a summary of the relevant content, generate a recommended action based on the content, provide the summary, the recommended action, and an option to implement the recommend action to a user in a presentation in a variety of formats, and initiate the recommended action. Accordingly, the provider computing system 104 is communicably and operably coupled to user devices 102, content sources 106, and decision implementation services 108. Provider computing system 104 includes network interface 121, system database 122, and a content summary and recommendation system 123.

Network interface 121 includes program logic that facilitates connection of the provider computing system 104 to the network 110. Accordingly, the network interface 121 supports communication via network 110 (e.g., via the internet) between the provider computing system 104, the user device 102, content sources 106, and decision implementation services 108. The network interface 112 may include a cable modem, a broadband modem, a cellular modem, a Bluetooth transceiver, a Bluetooth beacon, a radio-frequency identification (RFID) transceiver, and/or a near-field communication (NFC) transmitter. In some embodiments, the network interface 121 includes cryptography capabilities to establish a secure or relatively secure communication session.

System database 122 is configured to store a user profile for each user. Each user profile includes user preferences, data relating to the user's financial situation, and user goals. User preferences refer to the format of output that a user desires to receive, the user devices 102 the user uses and electronic addresses for contacting those devices via network 110, particular content sources that the user trusts or distrusts, pre-authorizations to carry out certain types of recommended actions, and other relevant preference settings. Data relating to the user's financial situation includes, for example, the user's bank account balances, credit card balances, debt (e.g., student loans, mortgages), investment portfolio, a list of major assets (e.g., real property, expensive art and jewelry, automobiles), income, etc. User goals include a user's short and long term financial-related desires, for example to retire in a certain number of years, to make a substantial purchase (e.g., a car, house, vacation), to fund a child's education, among other possibilities. Information in the user profiles may be added by a user via user devices 102, may be retrieved from content sources 106 (e.g., financial institution systems 136), or may be determined by the provider computing system 104 based on some combination of data available from user devices 102 and one or more content sources 106. For example, a user's explicitly-stated goal to buy a new car input via user device 102 may be modified based on information derived from social media platforms 132 that suggest that the user is more interested in a dream vacation than in buying a new car (e.g., based on the user's repeated posts about vacation destinations and “likes” of vacation-related posts combined with an absence of car-related activity).

The system database 122 is further configured to store any other data, information, documents, files, objects, code, etc. needed to facilitate any of the functions described herein. Accordingly, the system database 122 stores content imported from content sources 106 and/or summaries of content generated by the output generation circuit 128. The system database 122 may store recommendations generated by the recommendation circuit 126, as well as a history of recommendations made to a user and the user's response to those recommendations. The system database 122 may also store stock illustrations, visuals, audio, images, icons, etc. for inclusion in outputs (presentations) generated by the output generation circuit 128 and described in more detail below.

The content summary and recommendation system 123 is structured to locate content relevant to a user, curate that content to generate a summary of the relevant content, generate a recommended action based on the content, provide the summary, the recommended action, and an option to implement the recommend action to a user in a variety of formats, and initiate the recommended action. In various alternative embodiments some or all of the elements and/or features of the content summary and recommendation system 123 may be additionally and/or alternatively included with or executed by the content summary and recommendation system client application 117 of a user device 102. The content summary and recommendation system 123 includes content monitoring circuit 124, recommendation circuit 126, output generation circuit 128, and decision implementation circuit 130.

The content monitoring circuit 124 is configured to monitor the content generated and/or provided by content sources 106, identify content that is relevant to a user's profile, and import the identified content to the system database 122. To monitor content generated by content sources 106, the content monitoring circuit 124 is communicably coupled to content sources 106 via network interface 121 and network 110. According to various embodiments, the content monitoring circuit 124 checks content sources 106 for new content constantly, at periodic intervals, in response to a request from a user, and/or in response to an indication from one or more of content sources 106 indicating that new content has been added. In some embodiments, the content monitoring circuit 124 is configured to filter out unreliable or distrusted content, for example by cross-checking information from multiple content sources for consistency and/or by following a user preference indicating trusted sources (e.g., the user may trust Fox News over other news outlets).

To identify content relevant to a user's profile, the content monitoring circuit 124 is communicably coupled to the system database 122 to access user profiles. The content monitoring circuit 124 is configured to analyze information included in a user profile, for example a user's preferences, financial situation, and goals, to generate criteria for identifying relevant content. For example, criteria may include a list of companies the user has invested in, competitors, customers, or suppliers of those companies, products or services that a user might be interested in (e.g., loans, vacations, cars, homes), and any other category of information relevant to a user's finances. The content monitoring circuit 124 then uses these criteria in checking content sources 106 for new content to determine which, if any, content is relevant to a user. The content monitoring circuit 124 then imports the relevant content to the system database 122. In some embodiments, the content monitoring circuit 124 copies, downloads, etc. files (e.g., documents, audio, video, images) from content sources 106 to store in the system database 122. In some embodiments, the content monitoring circuit 124 determines the relevant information and ideas in the content (e.g., the facts of a news story), separates that information from creative expression of the content creator (e.g., from videos, illustrations, writings) to avoid risks of copyright infringement, and stores the information in the system database 122. In some embodiments, the content monitoring circuit identifies electronic addresses of relevant content (i.e., directions on how to get back to the content) and provides those addresses to the recommendation circuit 126 and/or the output generation circuit 128 in addition or instead of importing content to the system database 122.

The recommendation circuit 126 is configured to analyze the content identified by the content monitoring circuit 124 and determine a recommended user action based on the content. In some cases, the recommendation circuit 126 is also configured to access content source 106 to search for contextual or complementary content not directly related to the user's profile but impacting a possible recommended user action. The recommendation circuit 126 analyzes the identified content to determine an action the user can take in reaction to the new content to help the user achieve the user's goals. Possible recommendations include a recommendation to buy or sell an investment instrument (e.g., stocks, bonds, other tradeable assets or collections thereof), buy or sell a major asset (e.g., a home or car), apply for a particular loan or mortgage, refinance debts, open a new bank account or credit card, book a vacation, retire, apply for new jobs, and select an insurance option, among other possibilities.

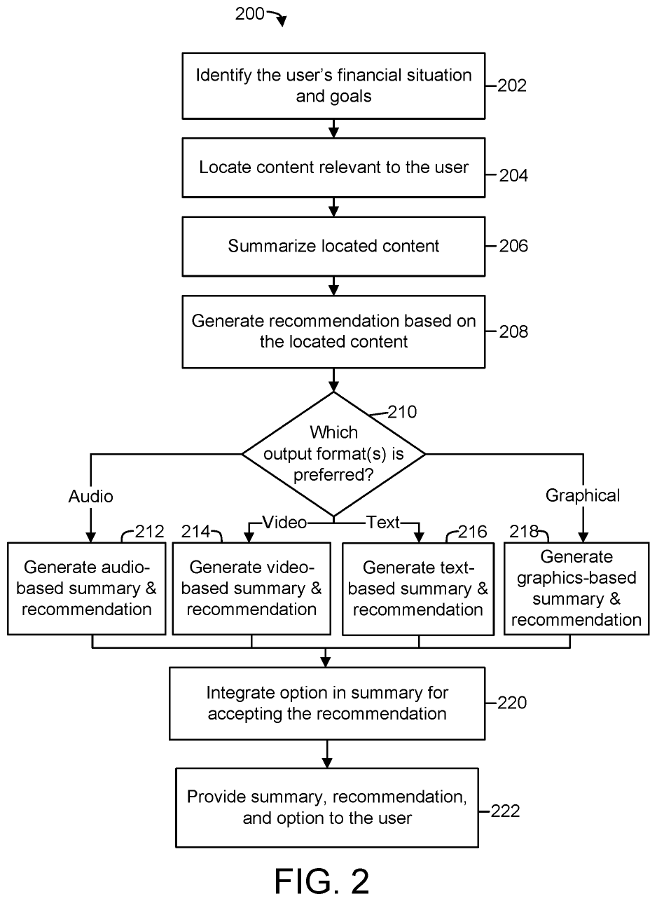

The output generation circuit 128 is configured to generate an presentation (output) for communication to a user that includes the recommended user action from the recommendation circuit 126 and a summary of the content relevant to that recommendation. As described in detail with reference to FIGS. 2-6, the presentation may be provided in one or more of many possible formats on one or more of a variety of types of user devices 102. Accordingly, the output generation circuit 128 is configured to determine the appropriate output format or formats, for example based on a user's preferences, the user devices 102 associated with the user, a determined urgency level of the content and/or the recommend action, or some other factor. The output generation circuit 128 is further configured to summarize the content and generate a text summary, a graphical user interface including the summary, an audio summary, a video summary, or some combination thereof. In various cases, the output generation circuit 128 includes short copies of relevant content in the summary (e.g., video clip from a news broadcast about the news), simulates voices and/or faces stating the summary, generates graphs, charts, or other useful visualizations, and/or creates any other effective way of communicating information to a person via one or more user devices 102. For example, the output generation circuit 128 may identify relevant subsections of one or more videos from the content sources, snip the relevant subsections from the one or more videos, and compile the relevant subsections to generate the summary. The output generation circuit 128 is further configured to integrate the recommendation generated by the recommendation circuit 126 into the summary and integrate an option, selectable by the user, to implement the recommendation. The output generation circuit 128 is further configured to cause the presentation to be transmitted to one or more user devices 102 via network interface 121 and network 110.

The decision implementation circuit 130 is configured to receive a user selection (i.e., made via input/output circuit 116 of a user device 102) of an option to implement a recommended action and to initiate the recommended action. The decision implementation circuit 130 is communicably coupled via network 110 with the decision implementation services 108 to instruct the decision implementation services 108 to execute actions on behalf of the user. For example, the decision implementation circuit 130 may compile a packet of information containing the user's personal information (e.g., name, account number, payment method information) and an identification of the action to be taken (e.g., a identifier of a particular investment instrument and an amount of money to invest in that instrument). In various embodiments, the decision implementation circuit 130 is further configured to request more information from a user via a user device 102 as required to implement a recommendation (i.e., when a decision implementation service requires user information not already stored in the system database 122) and/or to receive a confirmation from the decision implementation services 108 that a decision was implemented and forward that confirmation to one or more user devices 102.

Referring now to FIG. 2, a flowchart of a process 200 for providing a news summary including a recommendation to a user is shown, according to an example embodiment. Process 200 can be carried out by the provider computing system 104 and the content summary and recommendation system 123, and reference is made to elements thereof for the sake of clarity. At step 202, the user's financial situation and goals are identified. The user's financial situation refers to the user's bank account balances, debts, credits, investment portfolio, assets, income, etc. The user's goals refer to the user's desires and aspirations, for example retiring at a certain age, saving a certain amount of money, making a particular large purchase, etc. According to various embodiments, the user's financial situation and goals are received by the content summary and recommendation system 123 as input to user devices 102, are derived from information found in content sources 106 (e.g., in a user's account in a financial institution system 136, from user statements on social media platforms 132), or some combination of the two.

At step 204, the content summary and recommendation system 123 locates content relevant to the user's situation and goals. For example, the content summary and recommendation system 123 locates content in content sources 106, including news media platforms 131, social media platforms 132, government databases 134, and financial institution systems 136. Locating content may include key-word searching, natural language processing, speech recognition, and/or artificial intelligence approaches to analyze content.

At step 206, the content summary and recommendation system 123 summarizes the located content. Summarizing the located content includes identifying main points of the located content as well as the relevance of those main points to the user. Summarizing the located content may include evaluating the relatively reliability and accuracy of multiple content sources, drawing from and aggregating portions of multiple content sources, and contextualizing the content based on other relating content or information about the user stored in the system database 122.

A variety of approaches to summarizing the located content are possible. For example, in some embodiments the content summary and recommendation system 123 uses natural language processing to read, analyze, and understand the subject matter of the located content. An artificial intelligence and/or machine learning approach may then be used to determine the relevance of the subject matter of the content to the user, and determine which facts or other pieces of content are most important for the user. The content summary and recommendation system 123 may then extract these relevant pieces of content from the located content, for example by copying relevant sections from the content or by independently generating a restatement of the important facts. The extracted relevant pieces of content are then packaged as a summary of the located content in a data format that can be used as described below to generate a recommendation and a user-facing presentation (i.e., in some cases the summary at step 206 may be a computer-readable summarized content not yet formatted to be comprehensible to a user).

At step 208, the recommendation circuit 126 generates a recommendation based on the summarized content (i.e., on the relevant pieces of content). The recommendation is for a recommended user action (or, in some cases, inaction) that is determined to be likely to help the user reach the users goals based on the user's profile (e.g., the user's financial situation) and the located content. According to various embodiments, the recommendation circuit 126 generates recommendations using comparisons to historical datasets (i.e., to compare the user to what happened to another person tracked in the data), models and simulations (e.g., to simulate what will happen if a user makes a particular decision), preset rules (e.g., to recommend selling a stock if value drops at a certain rate), and/or other approaches. In some cases, the recommendation includes an option selectable by a user via user device 102 to implement the recommended action.

For example, in some embodiments the recommendation circuit 126 first characterizes the relationship between the summarized content and the user's situation (e.g., current investments, loans, accounts, job, etc.) and goals. The relationship may be understood as the reason why the content was deemed relevant to the user, for example the content relates to a stock owned by the user, a stock the user might purchase, a story relevant to an income stream of the user, etc. For each type of relationship, in such embodiments, the recommendation circuit 126 stores several possible types of stories that further characterize the content. For example, if the relationship is that the user owns stock involved in the summarized content, possible types of stories include a plummeting stock value, an increasing stock value, an announcement about dividend payments, etc. The recommendation circuit 126 may further store a recommendation type associated with each type of story (e.g., plummeting stock value is associated with a recommendation to sell the stock). In order to generate a recommendation, the recommendation circuit 126 determines the relationship and the type of story, and then accesses the stored associated recommendation. The recommendation circuit 126 can thereby look up recommendations for a wide variety of summarized content. As mentioned above, various other approaches to recommendation generation are also possible.

The recommendation circuit 126 may then use a machine learning or artificial intelligence approach to characterize the type of story told by the summarized content relative to the user. That is, the recommendation circuit 126 characterizes a change or other event from the content in generic terms (e.g., loss of owned stock value, low price now available for investment, lower interest rates now available. Each type of relationship between a user and the content may have a set of possible associated stories/changes to choose from.

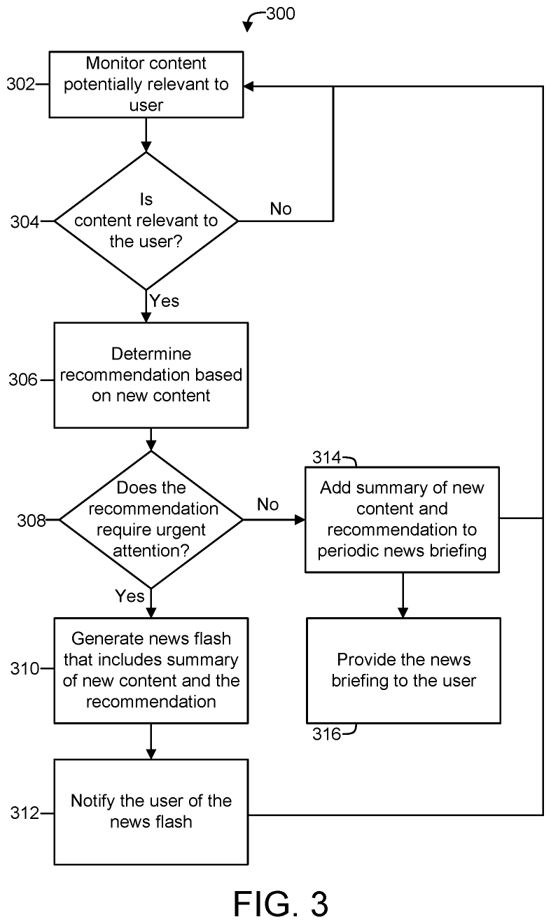

At step 210, the output generation circuit 128 determines which output format is preferred for presenting the summarized content and the recommendation to the user. In some embodiments, this determination is based on the urgency of the content and the recommendation as described in more detail in reference to FIG. 3. In some embodiments, this determination is based on user preferences stored in the system database 122, a list of user devices 102 corresponding to the user stored in the system database 122, a user request made via a user device 102, and/or other considerations. In some cases, one or more formats are created of the same presentation for the same user. For example, the preferred output format is audio if the user preferences state that the user likes to listen to summaries and recommendations via an automobile entertainment system. As another example, the preferred output format is video if the user always uses a television to view summaries and recommendations. As another example, the preferred output is text-based if the user explicitly requested text-based summaries and recommendations via a user device 102. As another example, in some embodiments a graphical format is chosen in addition or alternatively to other formats to consistently provide access to the summaries and recommendations on a graphical user interface available on a user device 102 such as a smartphone or laptop.

If an audio format is preferred, at step 212 the output generation circuit 128 generates an audio-based summary and recommendation. Generating the audio-based summary and recommendation may include generating a script and simulating the sound of a voice reading the script. In some embodiments, the audio-based presentation includes copies of segments of audio from radio or television broadcasts. According to some embodiments, then, the audio-based presentation is the noise of a voice telling the news and the recommendation to the user.

If a video format is preferred, at step 214 the output generation circuit 128 generates a video-based summary and recommendation. Generating the video-based summary and recommendation may include generating a script and simulating the sound of a voice reading the script as well as simulating a face saying the words. In some cases, the video-based summary and recommendation may include graphs, charts, illustrations, photographs, and other visualizations. In some embodiments, the video includes copies of segments of video or audio from television broadcasts or other videos available in content sources 106. The video may include music and other sound effects. The video-based presentation thus includes noise and moving pictures that relate the news and the recommendation to the user.

If a text format is preferred, the output generation circuit 128 generates a text-based summary and recommendation at step 216. Generating the text-based summary and recommendation includes generating a series of words in natural language that describe the summarized content and the recommendation. The text format may be an text message (SMS, internet-based chat, etc.). In some embodiments, the output generation circuit 128 provides for an interactive chatbot that informs the user about the summarized content and the recommendation.

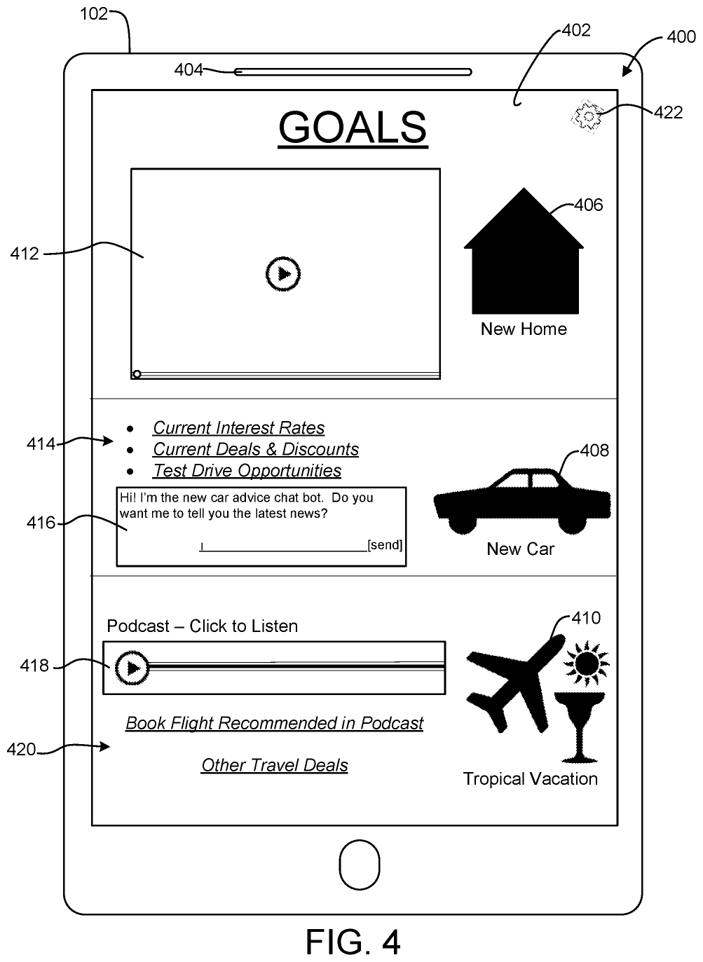

If a graphical format is preferred, at step 218 the output generation circuit 128 generates a graphical user interface that includes the summary and recommendation. The graphical user interface includes visualizations, text, and other features to communicate the summary and the recommendation to the user. In some cases, for example as shown in FIG. 4, a graphical user interface may be embedded with a video, an audio module, and a chat box, such that steps 212-218 overlap and combine.

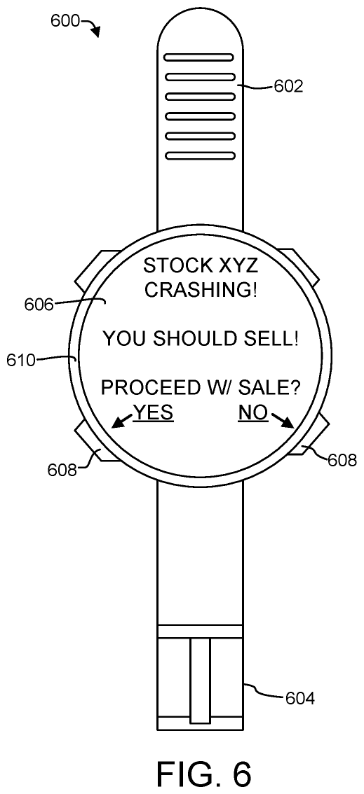

At step 220, the output generation circuit 128 integrates an option for accepting the recommendation into the presentation (i.e., included with the summary and recommendation outputs). The option may take a variety of forms depending on the output format. If the output format is audio, the option may be given as a voice prompt (e.g., the noise of a voice saying “Do you want to sell the stock?”), which the user can respond to audibly (e.g., by speaking back to answer the question as picked up by a microphone of the user device 102) or in some other way. If the output format is video, the option may be shown in the video, for example as selectable buttons embedded in the video as shown in FIG. 6D and described in detail with reference thereto. If the output format is text, the option may be given as the text of a sentence stating the question, which can be accepted with a response text message or other input from the user indicating an answer to that question. If the output format is a graphical user interface, a wide variety of buttons, sliders, drop down menus, text-entry fields, swipe-able screens and objects, and other interactive objects are possible for providing a means for accepting or declining a recommendation.

At step 222, the content summary and recommendation system 123 provides the summary, recommendation, and option to the user by transmitting the summary, the recommendation, and the option to one or more user devices 102 via network 110. If a user selects the option to accept or decline a recommendation, the content summary and recommendation system 123 also receives that feedback at the decision implementation circuit 130. The decision implementation circuit 130 then initiates the implementation of the recommended action in communication with one or more decision implementation services 108.

Referring now to FIG. 3, a flow chart of a process 300 of providing a news flash and news briefing including a recommendation to a user is shown, according to an example embodiment. Process 300 can be carried out by the provider computing system 104 and the content summary and recommendation system 123 of FIG. 1, and reference is made to elements thereof for the sake of clarity.

At step 302, the content monitoring circuit 124 monitors content available in content sources 106, for example to detect newly-available content (e.g., newly created, newly uploaded). The content monitoring circuit 124 may continuously monitor content sources 106 to detect the creation of new content, or may check periodically (e.g., every five minutes, hourly, daily, etc.) for new content. The content monitoring circuit 124 may therefore be configured to distinguish new content (i.e., that added since a preceding check) from existing content. In some cases, step 302 also includes searching content sources 106 for content relevant to a newly-created user goal or other newly-acquired information about the user.

At step 304, the content monitoring circuit 124 determines whether the new content is relevant to the user. The determination of relevancy is based on a comparison of the subject matter of the new content (i.e., the entities involved, the nature of the news, predicted repercussions of the news) with the user's financial situation and goals (e.g., companies a user is invested in, purchases the user wants to make). In some cases, determining relevancy may include searching content sources 106 for contextual or complementary information needed to determine if the informational substance of the content will have any potential effect on the user's finances. If the content is determined to not be relevant to the user, the process 300 returns to step 302 to continue to monitor content.

If the content is determined to be relevant to the user, at step 306 the recommendation circuit 126 determines a recommendation based on the content. According to various embodiments, determining a recommendation includes comparisons to historical datasets (i.e., to compare the user to what happened to another person tracked in the data), models and simulations (e.g., to simulate what will happen if a user makes a particular decision), preset rules (e.g., to recommend selling a stock if value drops at a certain rate), and/or other approaches. The recommendation determined at step 306 may be a recommended user action (e.g., to sell a stock, to buy a house, to change a retirement date) or a recommended user inaction (e.g., to hold a stock, maintain an investment, continue a schedule of loan repayments).

At step 308, the recommendation circuit 126 determines whether the recommendation requires the urgent action of the user. For example, a recommendation may require urgent attention and action from a user when it involves selling a stock with a rapidly falling price or buying a dream house just listed at a low price. In some cases, a recommended user inaction may also require urgent user attention to prevent a user from acting counter to the recommended inaction, for example to prevent a user from selling a stock due to fake news the user heard through other channels. Recommendations that do not require urgent attention include, for example, a recommendation to consider an offer for a mortgage at an interest rate that will stay open for a long time, the introduction of a new type of credit card or account that a user may be interested in, portfolio-level investment recommendations, and other longer-term considerations. The recommendation circuit 126 may determine the urgency of the recommendation based on the type of recommendation, the type of action recommended, user preferences, and/or other considerations.

If the recommendation circuit 126 determines that a recommendation requires the urgent attention of the user, at step 310 the output generation circuit 128 generates a news flash that includes a summary of the new content, the recommendation, and, where applicable, an option to implement a recommend action. The news flash may be formatted for presentation on one or more user devices to grasp the immediate attention of the user. For example, as shown in FIG. 6 and described in detail with reference thereto, a news flash may be formatted to be presented on a wearable smartwatch, and accompanied by beeps, alarms, vibrations, and other audible or tactile cues to get a user's attentions. In other cases, the news flash may be formatted for presentation on another type of wearable device, a smartphone, a tablet, a laptop, a virtual or augmented reality headset, etc.

At step 312, the user is notified of/with the news flash. The output generation circuit 128 transmits the news flash to one or more user devices 102 via network 110, and causes the user device 102 to get the user's attention, for example by ringing, vibrating, flashing, etc. The news flash is displayed by input/output circuit 116 of a user device 102. A user may respond to the news flash using input/output circuit 116 by selecting an option to accept or deny the recommendation and follow or not follow the recommended action. After the news flash is provided to the user at step 312, the process 300 returns to step 302 to continue to monitor new content.

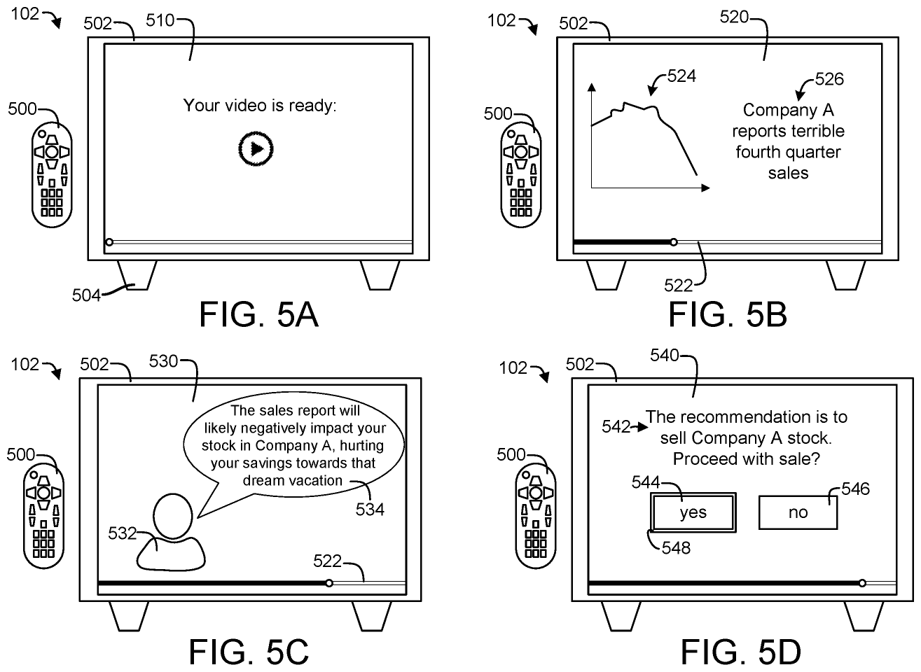

If the recommendation circuit determines at step 308 that the recommendation does not require a user's urgent attention, a summary of the new content and the recommendation are added to a periodic news briefing. In some cases, the periodic news briefing is an aggregation of summaries and recommendations, configured to be presented to a user at roughly even intervals, for example once a day or once a week. In some cases, the periodic news briefing is a graphical user interface accessible on demand that lists recent summaries and recommendations, for example as shown in FIG. 5. In some embodiments, summaries and recommendations added to the periodic news briefing may be revised or deleted based on further, related content later identified by the content monitoring circuit 124 that affects the accuracy of the summary or the wisdom of the recommendation.

At step 316, the news briefing is provided to the user. In some cases, the news briefing is provided to the user automatically or semi-automatically at roughly regular intervals. For example, a news briefing may be formatted for presentation by an automobile entertainment system that detects when a user is starting the user's morning or evening commute, accesses the news briefing, and provides the news briefing in an audio format to the user during the commute. A user voice assistant or smart-home speaker system is another example of a user device 102 that may provide the periodic news briefing to a user in an audio format at regular intervals, for example every day as the user eats breakfast. In some cases, the news briefing is accessed on demand, for example formatted as a graphical user interface accessible in an application or via a web browser on a mobile device or tablet. The content summary and recommendation system 123 is configured to generate and provide news briefings in each of multiple various formats for a variety of types of user devices 102.

Referring now to FIG. 4, a user device 102 displaying a graphical user interface 400 is shown, according to an example embodiment. In the example of FIG. 4, the user device 102 is a smartphone or tablet that includes a touch-screen 402 and a speaker 404. Graphical user interface 400 is an example of an output/presentation generated by the content summary and recommendation system 123 and provided to the user device 102, for example a periodic news briefing as discussed with reference to process 300 of FIG. 3.

Graphical user interface 400 is organized by user goals, as indicated by new home goal label 406, new car goal label 408, and tropical vacation label 410. Each goal label 406-410 indicates that the corresponding area of the graphical user interface 400 contains information relating to achieving that goal. The new home goal label 406 corresponds to a video player 412. The video player 412 is configured to play a video that includes a summary of new content relevant to the user's goal of purchasing a new home, a recommendation corresponding to that goal, and a selectable option to implement that recommendation. In some cases, the video includes sound played by speaker 404. The video played in video player 412 may include video or audio clips imported from content sources 106, illustrations, animations, overlaid texts, captions, etc. to communicate the summary and the recommendation to the user, as well as selectable buttons, sliders, or other objects to provide the user with an option to accept or decline the recommendation.

The new car goal label 408 corresponds to text-based recommendations, including links 414 and chat box 416. Links 414 are selectable by a user to navigate to another screen giving additional information about the topics indicated by the link (e.g., the link “Current Interest Rates” leads to a view of current interest rates). The links 414 may lead to another view within an application that supports the graphical user interface 400, or may launch a new application such as a web browser to present the additional information to the user. The chat box 416 provides the user with an opportunity to interactively request and receive news about the user's goal to acquire a new car. The chat bot provides text-based summaries and recommendations to the user in response to text-based inputs. For example, the graphical user interface 400 may launch a touch-screen keyboard when a user selects the chat box 416 so that the user can select characters on the keyboard to enter text into the chat box 416. The content summary and recommendation system 123 is configured to receive the text entered into the chat box 416, process the text to determine the nature of the information, question, or request contained in the text, and generate a response to provide in natural language in the chat box 416. An option to implement the recommendation may be given by the chat bot (i.e., generated as a natural language question by the content summary and recommendation system 123 and provided in the chat box 416), and may be accepted or declined by a text-based response (e.g., the user types “Yes”).

The tropical vacation label 410 corresponds to an audio player 418 and links 420. The audio player is selectable to play an audio-based summary and recommendation generated by the provider computing system. The audio-based summary is played to the user by speaker 404 and/or an external speaker system (e.g., a Bluetooth-connected speaker, a home entertainment system, an automobile entertainment system). In various cases, the audio-based summary includes audio clips taken from content sources 106, simulated voices, stock recorded voices (e.g., the provider computing system may store a recording of a person saying common words or phrases and uses those recordings to piece together the summary and recommendation), music, recorded sounds, and/or other sound effects. An option to accept or decline the recommendation is given in an audio format (e.g., the sound of a voice asking if the user wants to accept the recommendation). In the embodiment of FIG. 4, the user can respond by selecting a link 420 that states “Book Flight Recommended in Podcast.” In some embodiments, the user can accept or decline the recommendation orally by speaking to indicate approval or disapproval within range of a microphone of the user device 102.

The graphical user interface 400 thereby provides several output formats in a single view, with each type of output providing a summary of content relevant to the user, a recommendation based on that content, and an option to accept or decline the recommendation. A user may customize the output formats and other settings by selecting settings button 422. Although the graphical user interface 400 is shown as organized by user goals, any other suitable organization is possible, including ordered by urgency, impact (e.g., amount of money affected), chronologically, or user preference. In some embodiments, a single presentation (e.g., one video, one podcast, one chat session) includes a summary of content and recommendation(s) relating to more than one goal (e.g., the video discusses both the new home goal and the new car goal).

Referring now to FIGS. 5A-D, a series of illustrations of a user device 102 including a remote control 500 and a television 502 displaying a video-based presentation are shown, according to example embodiments. Remote control 500 includes buttons selectable by a user to control the television 502 and otherwise provide input to the user device 102. Remote control 500 communicates with the television 502, for example by sending pulses of infrared radiation to a detector on the television 502 or via some other wireless communication (e.g., Bluetooth, WiFi). In some embodiments, the remote control 500 is a smartphone configured to communicate with the television 502. The television 502 includes any type of video display (e.g., an LCD screen, a plasma screen, an OLED screen, a rear-projection display). In some cases, the television 502 includes one or more speakers or is communicable with a speaker system. The television 502 may stand on feet 504 as shown or may be wall-mounted. User device 102 in FIGS. 5A-D may also include any suitable television accessory or accessories (e.g., cable boxes, streaming devices, DVD/Blu-ray players, gaming consoles, sound systems) communicably and operably coupled to the television 502 to facilitate the functions described herein. A television accessory and/or the television 502 includes a network interface (i.e., network interface 112 of FIG. 1) configured to facilitate communication between the television 502, the remote control 500, and the provider computing system 104 via network 110.

FIG. 5A shows the television 502 displaying a start view 510 of the video presentation generated by the content summary and recommendation system 123. The start view 510 may appear as an alert when a recommendation is urgent (i.e., a news flash as in process 300 of FIG. 3), for example interrupting another video a user is watching or by automatically turning on the television 502, or may be accessed on demand by a user via inputs to remote control 500. When the start view 510 is shown, the remote control 500 allows the user to request that the video be played (e.g., by pushing a “play” button on the remote control 500).

FIG. 5B shows the television 502 displaying a first view 520 of the video presentation. Progress bar 522 shows that the video is partially completed. First view 520 includes a graph 524 and caption 526. The graph 524 may change as the video progresses, for example to show change to a value of an investment instrument over time. Other illustrations, graphs, charts, etc. may be included in the video presentation for display on television 502. The caption 526 explains a takeaway message from the graph 524, shown in FIG. 5B to include summarized news content. In some cases, a simulated voice reading the text of the caption or stating a relating message is played via one or more speakers.

FIG. 5C shows the television 502 displaying a second view 530 of the video presentation. Progress bar 522 indicates that the second view 530 occurs later in the video presentation than the first view 520. Second view 530 shows a person 532 stating a message 534. In various embodiments, the person 532 is an auto-generated animation or a clip of a person or animation taken from content sources 106. Person 532 is shown as a human form, but may include an animal or any anthropomorphized thing. As the video presentation plays, features of person 532 move to give the impression that person 532 is speaking the words in the message 534. As shown in FIG. 5C, the message 534 describes the effect of the summarized news of the first view 520 on the user's financial situation.

FIG. 5D shows the television 502 displaying an option view 540. The option view 540 includes a caption 542 that states the recommendation and asks if the user wants to follow the recommendation. The option view also includes a yes button 544 and a no button 546, embedded within the video. The user can toggle between the yes button 544 and the no button 546 using the remote control 500. As shown in FIG. 5D, an indicator 548 shows which of the yes button 544 and the no button 546 is selected, and may be initially presented with the yes button 544 to nudge the user towards accepting the recommendation. The progress bar 522 may continue to show that the video presentation is elapsing (i.e., continue to fill to the right) while the option view 540 is presented, or may pause until the user selects the yes button 544 or the no button 546. In some cases, the user is given a maximum amount of time to select the yes button 544 or the no button 546 before a default choice is made (e.g., to follow the recommendation). The user may use the remote control 500 to rewind or replay the video presentation to watch the video again before making a decision. In some embodiments, video continues to play behind the yes button 544 and the no button 546 and/or audio continues to play while the user makes a decision.

When the user makes a decision by inputting a selection of the yes button 544 or the no button 546, an indication of this selection is transmitted from the user device 102 to the content summary and recommendation system 123. As discussed above, the content summary and recommendation system 123 then initiates the steps needed to implement the recommendation. The video presentation continues on television 502, for example showing a confirmation that the selection was received by the content summary and recommendation system 123, a congratulatory message for choosing wisely, or some other conclusive view.

Referring now to FIG. 6, a watch 600 showing a text-based presentation with a summary, a recommendation, and an option to accept or decline the option is shown, according to an example embodiment. Watch 600 includes a strap 602 and a buckle 604 configured to secure the watch 600 on a person's wrist. Watch 600 also includes a display 606 and several buttons 608. In some embodiments, the display 606 is a touchscreen configured to accept input from a user. In some embodiments, bezel 610 is configured to accept input from a user. In some embodiments, watch 600 includes an accelerometer configured to accept input from a user through a shake or other movement of the watch 600. According to various embodiments, watch 600 also includes a speaker, a vibration generator, lights, or other features configured to capture the attention of the user.

The watch 600 receives the text-based presentation (e.g., a news flash as in process 300) from the content summary and recommendation system 123. In some embodiments, the watch communicates directly with network 110, while in some embodiments the watch accesses network 110 via another device such as a smartphone. Watch 600 is configured to buzz, vibrate, beep, flash and/or otherwise attempt to capture the attention of a user in response to receiving the text-based presentation. The text-based presentation is then displayed on display 606 as shown in FIG. 6. The display then shows a summary (“Stock XYZ is crashing”), a recommendation (“You should sell!”), and an option to implement the recommendation (“Proceed w/sale? Yes/No”). As shown in FIG. 6, the option to implement the recommendation is associated with buttons 608, such that one button 608 can be pressed by a user to select “Yes”, and another button 608 can be pressed by a user to select “No.” Various designs and arrangements for accepting an input of acceptance or rejection of a recommendation are possible, including touching buttons on a touch-screen, movement of the watch sensed by an accelerometer (e.g., simulating a handshake with the arm wearing the wrist to signal acceptance of the recommendation), scrolling through a list of options before selecting a preferred choice, etc. In some cases, the text-based presentation on watch 600 directs the user to another user device 102 (e.g., a smartphone or personal computer) to view more information about the summarized content and the recommendation.

The embodiments described herein have been described with reference to drawings. The drawings illustrate certain details of specific embodiments that implement the systems, methods and programs described herein. However, describing the embodiments with drawings should not be construed as imposing on the disclosure any limitations present in the drawings.

It should be understood that no claim element herein is to be construed under the provisions of 35 U.S.C. § 112(f), unless the element is expressly recited using the phrase “means for.”

As used herein, in various embodiments, the term “circuit” includes hardware structured to execute the functions described herein. In some embodiments, each respective “circuit” includes machine-readable media for configuring the hardware to execute the functions described herein. The circuit is embodied as one or more circuitry components including, but not limited to, processing circuitry, network interfaces, peripheral devices, input devices, output devices, sensors, etc. In some embodiments, a circuit takes the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” includes any type of component for accomplishing or facilitating achievement of the operations described herein. In one example, a circuit as described herein includes one or more transistors, logic gates (e.g., NAND, AND, NOR, OR, XOR, NOT, or XNOR), resistors, multiplexers, registers, capacitors, inductors, diodes, wiring, and so on.

In other embodiments, the “circuit” includes one or more processors communicably coupled to one or more memories or memory devices. In this regard, the one or more processors execute instructions stored in the memory or execute instructions otherwise accessible to the one or more processors. In various arrangements, the one or more processors are embodied in various ways and are constructed in a manner sufficient to perform at least the operations described herein. In some embodiments, the one or more processors are shared by multiple circuits (e.g., circuit A and circuit B comprise or otherwise share the same processor which, in some example embodiments, executes instructions stored, or otherwise accessed, via different areas of memory). Additionally, in various arrangements, a given circuit or components thereof (e.g., the one or more processors) are disposed locally (e.g., as part of a local server or a local computing system) or remotely (e.g., as part of a remote server such as a cloud based server). To that end, in certain arrangements, a “circuit” as described herein includes components that are distributed across one or more locations.

As used herein, a processor is implemented as a general-purpose processor, an application specific integrated circuit (ASIC), one or more field programmable gate arrays (FPGAs), a digital signal processor (DSP), a group of processing components, or other suitable electronic processing components. Additionally, in some arrangements, a “processor,” as used herein, is implemented as one or more processors. In certain embodiments, the one or more processors are structured to perform or otherwise execute certain operations independent of one or more co-processors. In other example embodiments, two or more processors are coupled via a bus to enable independent, parallel, pipelined, or multi-threaded instruction execution. In some arrangements, the one or more processors take the form of a single core processor, multi-core processor (e.g., a dual core processor, triple core processor, or quad core processor), microprocessor, etc. In some embodiments, the one or more processors are external to the apparatus, for example, the one or more processors are a remote processor (e.g., a cloud based processor). Alternatively, or additionally, the one or more processors are internal and/or local to the apparatus. Accordingly, an example system for implementing the overall system or portions of the embodiments might include a general purpose computing computers in the form of computers, including a processing unit, a system memory, and a system bus that couples various system components including the system memory to the processing unit.

Additionally, as used herein, a memory includes one or more memory devices including non-transient volatile storage media, non-volatile storage media, non-transitory storage media (e.g., one or more volatile and/or non-volatile memories), etc. In some embodiments, the non-volatile media takes the form of ROM, flash memory (e.g., flash memory such as NAND, 3D NAND, NOR, or 3D NOR), EEPROM, MRAM, magnetic storage, hard discs, optical discs, etc. In some embodiments, the volatile storage media takes the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. In various arrangements, each respective memory device is operable to maintain or otherwise store information relating to the operations performed by one or more associated circuits, including processor instructions and related data (e.g., database components, object code components, or script components), in accordance with the example embodiments described herein.

It should be understood that a “network interface,” as used herein, includes any of a cellular transceiver (Code Division Multiple Access (CDMA), Global System for Mobile Communications (GSM), Long-Term Evolution (LTE), etc.), a wireless network transceiver (e.g., 802.11X, ZigBee, or Bluetooth), or a combination thereof (e.g., both a cellular transceiver and a Bluetooth transceiver). In some arrangements, a network interface includes hardware and machine-readable media sufficient to support communication over multiple channels of data communication. Further, in some arrangements, the network interface includes cryptography capabilities to establish a secure or relatively secure communication session between the device including the network interface and other devices of the system 100 via the network 110. In this regard, data is encrypted and transmitted to prevent or substantially prevent the threat of hacking.

In certain embodiments, an “input/output circuit” as used herein includes hardware and associated logics configured to enable a party to exchange information with a computing device to which the input/output circuit is connected. In various embodiments, an input aspect of an input/output circuit allows a user to provide information to the computing device and includes, for example, a touchscreen, a mouse, a keypad, a camera, a scanner, a fingerprint scanner, an eye scanner, a sensor that detects movement, a microphone, a joystick, a user input device engageable to the computing device via a USB, wirelessly, and so on, or any other type of input device capable of being used with a computing device. In various embodiments, an output aspect of an input/output circuit allows a party to receive information from the computing device and includes, for example, a display, a printer, a speaker, illuminating icons, LEDs, an output device engageable to the computing device via a USB, wirelessly, and so on, or any other type of output device capable of being used with a computing device.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein show a specific order and composition of method steps, it is understood that in various embodiments the order of these steps differs from what is depicted. As an example, two or more steps are performed concurrently or with partial concurrence. Also, in various embodiments, some method steps that are performed as discrete steps are combined, steps being performed as a combined step are separated into discrete steps, the sequence of certain processes is reversed or otherwise varied, and/or the nature or number of discrete processes is altered or varied. Furthermore, the order or sequence of any element or apparatus is varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques, with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or as acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions can be made to the design, operating conditions and arrangement of the embodiments without departing from the scope of the present disclosure as expressed in the appended claims.

1. A provider computing system, comprising:
a network interface configured to facilitate communication with a content source, a decision implementation service, and a user device;
a processing system comprising a processor and memory, the memory structured to store instructions that are executable by the processor to cause the processor to:
monitor content from the content source to detect relevant content relating to a user, the content comprising the relevant content relating to the user and irrelevant content to the user;
extract a plurality of relevant pieces of content from the monitored content;
assemble the relevant pieces of content together to create a presentation;
generate a recommendation based on the extracted plurality of relevant pieces of content, the recommendation identifying a recommended action;
modify the presentation by incorporating the recommendation in the presentation;
provide the presentation to the user device;
generate an option to implement the recommendation and provide the option to the user device;
receive, from the user device, an indication that the user selected the option to implement the recommendation; and
instruct the decision implementation service to execute the recommended action in response to receiving the indication.

2. The provider computing system of claim 1, wherein the recommended action comprises a financial transaction.

3. The provider computing system of claim 1, wherein:
the processing system provides the presentation to the user device in a video format; and
the processing system creates the presentation by:
accessing one or more videos from the content source;
identifying relevant subsections of the one or more videos;
snipping the relevant subsections from the one or more videos; and
assembling the relevant subsections into a summary video.

4. The provider computing system of claim 1, wherein the processing system provides the presentation to the user device in an audio format and the user device comprises an automobile entertainment system or a user voice assistant.

5. The provider computing system of claim 1, wherein the processing system provides the presentation to the user device in a text format and the user device comprises a watch.

6. The provider computing system of claim 1, wherein the processing system provides the presentation to the user device in a graphical user interface format and the user device comprises a smartphone, a tablet, a laptop, or a desktop computer.

7. The provider computing system of claim 1, wherein the processor is further configured to determine a preferred output format for the presentation from a plurality of possible output formats, the plurality of possible formats comprising audio, video, audio-video, text, and graphic.

8. The provider computing system of claim 7, wherein the processor is configured to determine the preferred output format from the plurality of possible output formats based on an urgency of the recommendation.

9. The provider computing system of claim 7, the processing circuit configured to store a user output preference and determine the preferred output format from the plurality of possible output formats based on the user output preference.

10. A method, comprising:
monitoring, by a provider computing system, content from a content source to detect relevant content relating to a user, the content comprising the relevant content relating to the user and irrelevant content to the user;
extracting a plurality of relevant pieces of content from the monitored content;
assembling the relevant pieces of content together to create a presentation;
generating a recommendation based on the extracted plurality of relevant pieces of content, the recommendation identifying a recommended action;
modifying the presentation by incorporating the recommendation in the presentation;
providing the presentation to a user device;
integrating an option to implement the recommendation into the presentation;
receiving an indication from the user device of a user selection of the option to implement the recommendation; and
causing execution of the recommended action in response to receiving the indication from the user device.

11. The method of claim 10, wherein the recommended action comprises a financial transaction.

12. The method of claim 10, wherein:
the presentation comprises a video;
the user device comprises a television;
extracting a plurality of relevant pieces of content comprises:
accessing one or more videos from the content source;
identifying relevant subsections of the one or more videos; and
snipping the relevant subsections from the one or more videos; and
assembling the relevant pieces of content comprises:
assembling the relevant subsections to create the presentation.

13. The method of claim 10, wherein the presentation is in an audio format and the user device comprises an automobile entertainment system or a user voice assistant.

14. The method of claim 10, wherein the presentation is in a text format and the user device comprises a watch.

15. The method of claim 10, wherein the presentation is in a graphical user interface and the user device comprises a smartphone, a tablet, a laptop, or a desktop computer.

16. The method of claim 10, further comprising determining a preferred presentation format from a plurality of possible presentation formats based on one or more of an urgency of the relevant content or a user preference included in a user profile, the plurality of possible presentation formats comprising audio, video, audio-video, text, and graphic.

17. A user device, comprising:
a network interface configured to facilitate communication between the user device and a content source; and
a processing system comprising a processor and memory, the processing system configured to:
monitor content from the content source to detect relevant content relating to a user, the content comprising the relevant content relating to the user and irrelevant content to the user;
extract a plurality of relevant pieces of content from the monitored content;
assemble the relevant pieces of content together to create a presentation;
generate a recommendation based on the extracted plurality of relevant pieces of content, the recommendation identifying a recommended action; and
modify the presentation by incorporating the recommendation and an option to implement the recommendation in the presentation; and
an input/output circuit configured to provide the presentation to the user and to receive a selection of the option to implement the recommendation;
wherein the processing system is further configured to cause execution of the recommended action to implement the recommendation in response to receiving the selection of the option via the input/output circuit.

18. The user device of claim 17, wherein the user device comprises a television and the input/output circuit comprises a television display and a television remote control.

19. The user device of claim 17, wherein the user device comprises a watch and the input/output circuit comprises a display of the watch and one or more of a touchscreen, a button, a bezel, or an accelerometer.

20. The user device of claim 17, wherein the user device comprises an automobile entertainment system and the input/output circuit comprises a speaker and a microphone.
